(19) United States
(12) Patent Application Publication
(10) Pub. No.: US 2012/0154163 A1
(43) Pub. Date: Jun. 21, 2012

(54) SECURITY SYSTEM

(76) Inventor: Kevin JONES, Hertfordshire (GB)

(21) Appl. No.: 12/971,060

(22) Filed: Dec. 17, 2010

(51) Int. Cl. G08B 21/00; G06F 19/00

(52) U.S. Cl. 340/657; 702/62

(57) ABSTRACT

A security system comprising apparatus for connecting a plurality of electrical devices (1) to a mains power supply (2), and a controller (10). The apparatus is provided with a plurality of power outlets, each outlet being associated with a sensor (3) for measuring at least one electrical parameter such as current drawn, power consumption or power factor at the power outlet. A communications interface (8) is provided for sending to a controller via a communications network a message. The message includes an identity of each power outlet of the plurality of power outlets and information derived from the measured electrical parameters. This information can be used by the controller to determine changes to electrical parameters which in turn can be used to determine whether the electrical device is still coupled to the apparatus, and activate an alarm (13) if it is determined that the electrical device is no longer coupled to the apparatus.

### TECHNICAL FIELD

The present invention relates to security systems, and in particular to a security system for an electrical device connected to a mains electricity supply.

### BACKGROUND

Theft of expensive and operation-critical electrical and electronic equipment is a constant concern in work environments including offices, educational establishments, hospitals, shops and hotels. Conventional intruder alarms, which typically use sensors such as door switches and passive infrared (PIR) devices, are of little use during working hours in such environments, since there is inevitably a constant flow of people, many of whom are unknown to the management of the organisation.

### SUMMARY

The inventor has realised the problems associated with security of electrical devices and has devised a security method, apparatus and system to improve the security of electrical devices. The mains current flowing to an electrical device is monitored. If this current falls below a predetermined threshold, then an alarm is raised. The detection of current is sufficiently sensitive to discern when the electrical device is in use, or if it is in a “standby” mode and drawing minimal current from the mains electricity supply.

According to a first aspect of the present invention, there is provided apparatus for providing mains electrical power to a plurality of electrical devices. The apparatus is provided with a plurality of power outlets, each power outlet arranged to be coupled to an electrical device. A plurality of sensors is provided, each sensor being associated with a power outlet of the plurality of power outlets. The sensors are arranged to measure at least one electrical parameter selected from current drawn, power consumption and power factor at the associated power outlet. A communications interface is provided for sending to a controller via a communications network a message. The message includes an identity of each power outlet of the plurality of power outlets and information derived from the measured electrical parameter for each power outlet of the plurality of power outlets. This information can be used by the controller to determine changes to electrical parameters which in turn can be used to determine whether the electrical device is still coupled to the apparatus.

As an option, the communications interface is further arranged to receive a polling signal from the controller, and the message is arranged to be sent in response to receipt of the polling signal.

The apparatus optionally comprises a microcontroller arranged to determine whether the electrical parameter has fallen below a predetermined threshold or outside a predetermined range and, in the event that such a determination is made, to send an alert message to the remote controller via the communications network. The alert message is therefore unsolicited, and not sent in response in response to a polling request. As a further option, the apparatus is provided with an alarm that is arranged to be activated in the event that it is determined that the electrical parameter has fallen below a predetermined threshold or outside a predetermined range.

Any suitable communications network can be used, such as an Ethernet network, a power line network, and a wireless network.

According to a second aspect of the invention, there is provided a controller for use in a security system. The controller is provided with a receiver for receiving a message from an apparatus for providing mains electrical power to a plurality of electrical devices. The message includes information derived from at least one electrical parameter selected from current, power consumption and power factor measured at each power outlet of a plurality of power outlets at the apparatus. A processor is also provided for activating an alarm in the event that the information derived from the electrical parameter has fallen below a predetermined limit or outside a predetermined range.

The processor is optionally further arranged to activate the alarm in the event that the message is not received within a predetermined time from sending the polling request and after a predetermined number of retries. This ensures that an alarm is raised if the apparatus is disconnected from the communications network or otherwise prevented from communicating with the controller.

The controller optionally comprises a transmitter for sending a polling request via a communication network to the apparatus for providing mains electrical power to a plurality of electrical devices, such that the received message is received in response to the polling request. As a further option, the polling request is sent to a plurality of apparatus for providing mains electrical power to a plurality of electrical devices, for example in the form of a broadcast. Alternatively the polling request is sent to an individual apparatus for providing mains electrical power to a plurality of electrical devices. In this case the polling request may comprise a request for information derived from at least one electrical parameter selected from current, power and power factor measured at all power outlets, or a request for information derived from at least one electrical parameter measured at an identified power outlet.

The receiver is optionally arranged to receive an alert signal from the apparatus for providing mains electrical power to a plurality of electrical devices, and the processor is arranged to activate an alarm in the event that an alert signal is received. This allows the apparatus to send an unsolicited alert message.

As an option, the controller comprises means to a deactivate a sensor located at a power outlet, and the processor is arranged to either send no more polling request messages for that sensor until it receives an indication to reactivate polling request messages or to ignore negative responses from that sensor to polling request messages. This allows a legitimate user who has appropriate authority to deactivate a sensor in order to be able to unplug the electrical device. As a further option, the processor is arranged to receive an indication to reactivate polling request messages after any of the expiry of a predetermined time limit and receipt of a reactivation message sent from the apparatus for providing mains electrical power to a plurality of electrical devices.

According to a third aspect of the invention, a security system comprises a monitor device located between the electrical device and the mains electricity supply. The monitor device comprises a sensor to measure at least one electrical parameter selected from current drawn, power and power factor relating to the electrical device. A transmitter is provided to send a message to a controller, the message including information derived from the measured electrical parameter. The controller is arranged to activate an alarm in the event that the information derived from the measured electrical parameter is outside one or more predetermined threshold ranges, or changes at greater than a predetermined rate.

As an option, the monitor device comprises a receiver to receive a polling signal sent from the controller, wherein the message is arranged to be sent in response to the polling signal.

As a further option, the predetermined thresholds correspond to typical power usage states of the electrical device.

The security system is optionally provided with a database accessible by the controller, the database containing information selected from typical electrical parameter values and rates of change of electrical parameter values for a plurality of electrical devices.

According to a fourth aspect of the invention, there is provided a controller for use in a security system. The controller comprises a receiver arranged to receive a message from a monitor device, the monitor device being located between an electrical device and a mains electricity supply and comprising a sensor device arranged to measure at least one electrical parameter selected from current drawn, power and power factor relating to the electrical device. The message includes information derived from the measured electrical parameter. A processor is arranged to determine whether the information derived from the measured electrical parameter is outside one or more predetermined threshold ranges, or has changed at more than a predetermined rate. Also provided are means to activate an alarm in the event that the information derived from the measured electrical parameter is outside one or more predetermined threshold ranges, or has changed at more than a predetermined rate.

The controller is optionally provided with a transmitter for sending a polling signal to the monitor device, the polling signal requesting the message from the monitor. As a further option, the controller is provided with means to activate the alarm in the event that the message from the monitor is not received within a predetermined time limit, and after a predetermined number of retries, after sending the polling signal.

According to a fifth aspect of the invention, there is provided a computer readable storage device storing a computer program which, when run on a computer device, causes the computer device to behave as a controller according to either of the second or fourth aspects of the invention described above.

### BRIEF DESCRIPTION OF THE DRAWINGS

For a better understanding of the present invention and in order to show how the same may be carried into effect reference will now be made by way of example to the accompanying drawings in which:

FIG. 1 illustrates schematically in a block diagram a network architecture according to an embodiment of the invention;

FIG. 2 illustrates schematically a network architecture in which a monitor is connected to several sensors;

FIG. 3 is a flow chart according to an embodiment of the invention;

FIG. 4 illustrates schematically exemplary acceptable current levels drawn by an electrical device according to an embodiment of the invention; and

FIG. 5 is a flow chart according to an embodiment of the invention.

### DETAILED DESCRIPTION

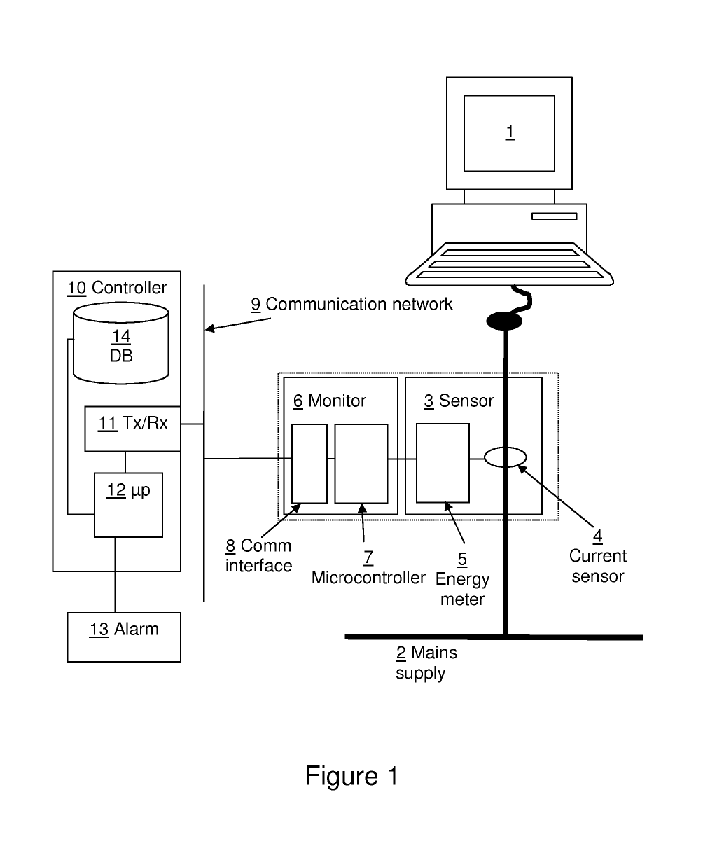

FIG. 1 shows an exemplary network architecture to assist in illustrating an embodiment of the invention. An electrical device 1 may, for example, be a computer or a piece of hospital equipment. It draws power from a mains power supply 2. A sensor 3 is interposed between the electrical device 1 and the mains power supply 2. The sensor 3 incorporates current measurement means 4 for measuring the current drawn from the mains power supply 2. Suitable current measurement means include shunt resistors, current transformers, Hall effect devices and Rogowski coils. An energy meter 5 is also provided at the sensor 3 in order to interpret readings from current measurement means 4 and, optionally, derive further data such as power drawn and power factor. The energy meter 5 may keep an integrated record of the current or power drawn, with the integrated power being measured over at least one cycle of the alternating power supply. Note that the energy meter may also keep a record of more than one parameter, so for example may record current drawn and power factor, or power and power factor.

The sensor 3 is connected to a monitor 6, which comprises a microcontroller 7 in communication with the energy meter 5, and a network interface 8. The network interface 8 allows the monitor 6 to communicate with remote devices via a communications network 9. Any suitable communications network 9 may be used, such as an Ethernet network, a Wireless Local Area Network (WLAN) or a power-line communications network. In this exemplary embodiment, an Ethernet network is assumed, as Ethernet networks are commonly used in office, hospital and factory environments in which the invention might typically be used. In a home environment, which is less likely to have an existing Ethernet network, a WLAN may be a more suitable communications network.

The network interface 8 allows the microcontroller 7 to send and receive information to and from a controller 10 via the Ethernet network 9.

The controller 10 comprises a communications interface 11, typically a transceiver or transmitter and receiver with which to send and receive communication via the communications network. It also comprises a processor 12. The processor 12 is arranged to activate an alarm 13 under certain circumstances. For certain embodiments of the invention, described below, the controller also has access to a database 14 that stores information relating to acceptable current thresholds, power factors and rates of change of current and power factor for a variety of common electrical devices. In this example, the database 14 is shown as part of the controller 10, although it will be appreciated that the database 14 may be located remotely from the controller 10 and accessible via the communications network 9. It will be appreciated that the controller can be implemented as an application running on a server or personal computer, or may be a dedicated controller device.

When an electrical device 1 is attached to the mains power supply 2 with a sensor 3 interposed between the electrical device 1 and the mains power supply 2, the controller 10 periodically sends a polling request message to the monitor, requesting information about one or more of the sensors associated with that monitor 6. Note that the controller 10 is typically in communication with several monitors 6. The polling request message may be a broadcast to all monitors asking for a response, or may be directed to a specific monitor 6. Furthermore, where the polling request is directed to a specific monitor, it may further be directed to a particular sensor 3 attached to the monitor 6.

The microcontroller 7 is notified of the polling request message received at the network interface 8, and obtains data such as current, power and power factor from the energy meter 5. It sends a response message to the controller via the communications network informing the controller of the data retrieved from each sensor 3 connected to the monitor, and an identifier for each sensor.

If the controller does not receive a response message after a predetermined time, it may try re-sending the polling request. If a response message is still not received after a pre-determined number of retries, then the monitor 6 is deemed to have been disconnected from the mains supply and the controller 10 activates the alarm, notifying a user that the monitor 6 is not responding to the polling request. By assigning identities to each monitor 6, the alarm can indicate the identity and location of the monitor 6.

Similarly, if the response message indicates that the current drawn by an electrical device has dropped below a predetermined threshold (which is typically below the current threshold for the device in “standby” mode), then the electrical device associated with the sensor 3 is deemed to have been disconnected and the controller 10 activates the alarm 13. By assigning identities to each sensor 3, the alarm can indicate the identity and location of the sensor 3 and, indirectly, the electrical device 1 being monitored by that sensor 3.

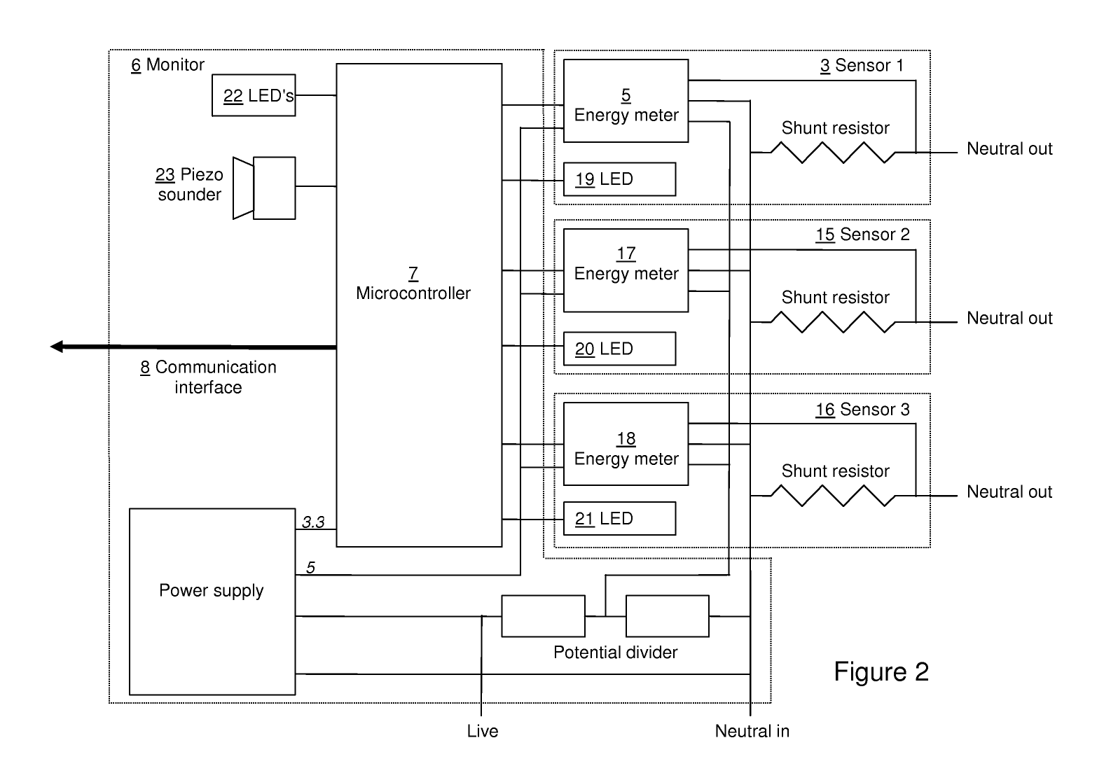

Turning now to FIG. 2, a specific embodiment of the invention is illustrated in which a monitor is connected to a plurality of sensors. This may typically be implemented in, for example, a multi-way adapter (FIG. 2 illustrates a three way adapter). The advantage of this arrangement is that a plurality of electrical devices can be monitored but only one communications interface is required. This is advantageous where an Ethernet communications network is used, as spare Ethernet ports may be at a premium. A further advantage of this arrangement is that costs can be reduced as only one monitor is required for a plurality of electrical devices.

In this embodiment, the microcontroller 7 of the monitor 6 is connected to three sensors 3, 15, 16. Each sensor has its own energy meter 5, 17, 18 and a Light Emitting Diode (LED) 19, 20, 21 to indicate its operational status. The multi-way adapter has three power outlets, each of which can be used to supply power to an electrical device. Each sensor 3, 15, 16 is associated with one of the three power outlets and so is indirectly associated with the electrical device drawing power from that power outlet.

The microcontroller 7 checks the current measurements reported by each of the sensors 3, 15, 16 with which it is associated. When the microcontroller receives a polling request from the controller 10, the response message includes information identifying the monitor 6, information identifying each sensor 3, 15, 16 and the current (or other current related parameter such as power) measured by each sensor 3, 15, 16.

Note that in one embodiment the monitor 6 may send an unsolicited alert message to the controller 10 in the event that the current measured by any of the associated sensors 3, 15, 16 falls below a predetermined level. If the controller receives such an alert message, an alarm is raised. This embodiment may be used with or without the above-described embodiment of sending polling requests.

The monitor 6 may also be provided with one or more LEDs 22 to indicate various states of the monitor (such as alarm raised, receiving and responding to polling request, no devices connected etc.). Furthermore, the monitor may be provided with an alarm such as a piezo-electric sounder 23 to sound in the event of an alarm condition.

It is preferred that communications between the controller 10 and the monitor 6 are encrypted. This is to reduce the likelihood of a sophisticated third party accessing the communication network 9 and sending messages to the controller that spoof the monitor 6.

It will be appreciated that a user may wish to disconnect an electrical device for legitimate reasons. In order to achieve this, the controller 10 may send a deactivation message to the monitor 6, instructing that one or more sensors 5, 15, 16 associated with that monitor 6 are to be deactivated. If, for example, a sensor 16 is deactivated, then the controller 10 may ignore any negative results from that sensor 16.

Where the controller 10 is implemented in a server or personal computer, it may use a web interface or similar, so that users can activate and deactivate their own sensors. If such a system is implemented, an authentication system is required to ensure that sensors are activated and deactivated only authorised users. In a preferred embodiment, a hierarchical authentication system is provided in which sensors are organised into groups (which typically relate to a specific department or workgroup), groups of groups and so on. In this way, a straightforward configuration can be built in which, for example, some users have no authority at all to activate or deactivate sensors, some can activate and deactivate only the sensors associated with their workstation, some can activate and deactivate all the sensors within their department, and others can activate and deactivate all sensors.

In one embodiment of the invention, the deactivation of a sensor 16 lasts until the monitor 6 receives a reactivation message from the controller 10. In an alternative or additional embodiment, deactivation may have a time limit, after which the sensor 16 is automatically reactivated. Typical time limits range from a few minutes, to allow a user to move an electrical appliance within his office, to a weekend or a few days, to allow a user to take electrical appliances with him when he is away from his regular place of work. Furthermore, the system may be configured either to reactivate the sensor 16 immediately an electrical device is reconnected to it, or to allow multiple disconnections and reconnections within the specified time limit.

The controller 10 may allow suitably authorised users to delete sensors from the controller's database, or add extra sensors, at any time in order to respond to changing needs in a security system, for example when new electrical devices is to be added to the system, or existing electrical devices are to be moved to different departments. The controller 10 may also be arranged to recognise new monitors being connected to the system, and assign them identifiers and add them to the controller's database automatically.

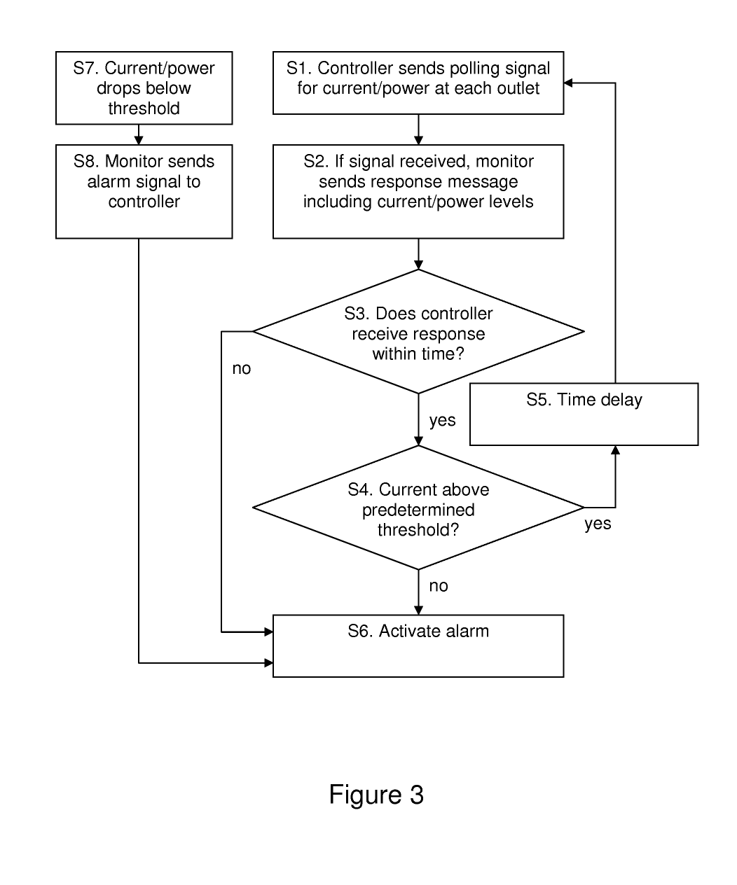

Turning now to FIG. 3, the above-described embodiment is illustrated as a flow chart, with the following numbering corresponding to the numbering of the flow chart:

S1. The controller 10 sends a polling signal to the monitor 6.
S2. When the monitor 6 receives the signal, it sends a response message to the controller 10. The response message includes the current/power measured by each sensor for each power outlet served by the monitor 6, although alternatively the response could simply include an indication of whether the monitor has determined if the electrical device 1 is still connected.
S3. If the controller 10 does not receive the response within a predetermined time, and/or after sending a predetermined number of retries, an alarm is activated (go to step S6).
S4. If the controller 10 receives the response message, it checks that the current/power for each sensor 3, 15, 16 is above a predetermined threshold. If not, then an alarm is activated (go to step S6). Alternatively, the monitor 6 may compare the measured current/power with predetermined thresholds, and send a message to the controller 10 indicating whether the measured current/power is within acceptable limits (see further embodiment described below).
S5. Assuming that the current/power measurement is acceptable, there is a delay before a new polling signal is sent (return to step S1).
S6. An electrical device is deemed to have been unplugged from the power supply, and so an alarm 13 is activated.
S7. As a separate matter, a monitor may determine that that the current/power measured by a sensor has dropped below a predetermined threshold, regardless of whether a polling signal has been received by the monitor 6.
S8. An alert signal is sent from the monitor 6 to the controller 10, which activates the alarm 13 (go to step S6).

When a large number of monitors are in use, and when monitors are polled individually, it is preferred that the polling requests sent from the controller are distributed across the chosen polling time interval, rather than all being sent out simultaneously.

In a further specific embodiment of the invention, the current or power measured by the sensor 3 is used to determine whether or not to activate an alarm depending on whether the current or power is outside one or more predetermined ranges. Additionally, an alarm can be raised if the current or power measured by the sensor 4 changes at greater than a predetermined rate.

In a further specific embodiment, the information returned by the sensor 3 can include power factor as well as or instead of current and/or power information. An alarm can be raised if the measured power factor falls outside predetermined ranges, or if the measured power factor changes at greater than a predetermined rate.

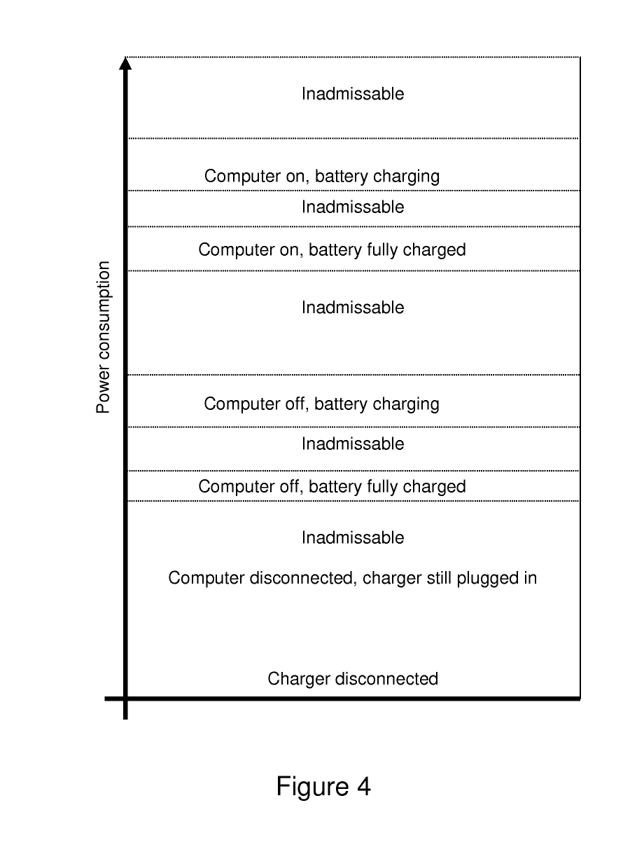

Referring to FIG. 4 herein, each range is associated with a different event. For example, if a sensor 3 is measuring the current drawn by a laptop computer 1, the sensor's sensitivity is typically such that it is able to differentiate between (in order of decreasing current consumption):

1. laptop switched on, battery charging
2. laptop switched on, battery fully charged
3. laptop switched off, battery charging
4. laptop switched off, battery fully charged
5. laptop disconnected from charger, charger still connected to mains supply
6. charger disconnected from mains supply

In this case, a threshold might be set such that an alarm is raised if either the charger is disconnected from the mains supply (current consumption less than at (6) above), or the laptop is disconnected from the charger (current consumption between (5) and (6)). Furthermore, a plurality of thresholds may be set for each sensor, with sufficient data being available for the controller to be able to report which alarm event has taken place.

An ingenious thief might attempt to break into the live mains supply to the electrical appliance 1 that he wishes to steal. He might then attempt to add an additional load so that, when he disconnects the electrical appliance, the current drawn does not fall to zero. In order to minimise his chances of success, a plurality of current ranges may be defined for each sensor, each current range being associated with one of the legitimate states of the associated electrical device. If, at any time, the current drawn falls outside the defined current ranges (shown as “Inadmissable” in FIG. 4), or if the current drawn falls outside the defined current ranges for more than a predetermined period of time, an alarm is raised.

Any attempt to introduce an extra load prior to removing an electrical appliance will also result in a change in the measured power factor, unless the power factor of the additional load is identical to that of the electrical device associated with the sensor 3 15 16. Therefore, in a preferred embodiment, an alarm is raised if the power factor measured at a sensor 3 15 16 falls outside a predetermined range, or if a measured power factor changes at more than a predetermined rate.

In order to minimise the work required in setting up ranges for a new electrical device 1 attached to the system, the controller 10 may be given access to a database 14 that contains default ranges of current and power factor for commonly used different types of electrical device. If such information is not available, then an option may be given via a user interface such as a web interface for allowing a user to define acceptable ranges for a particular electrical device.

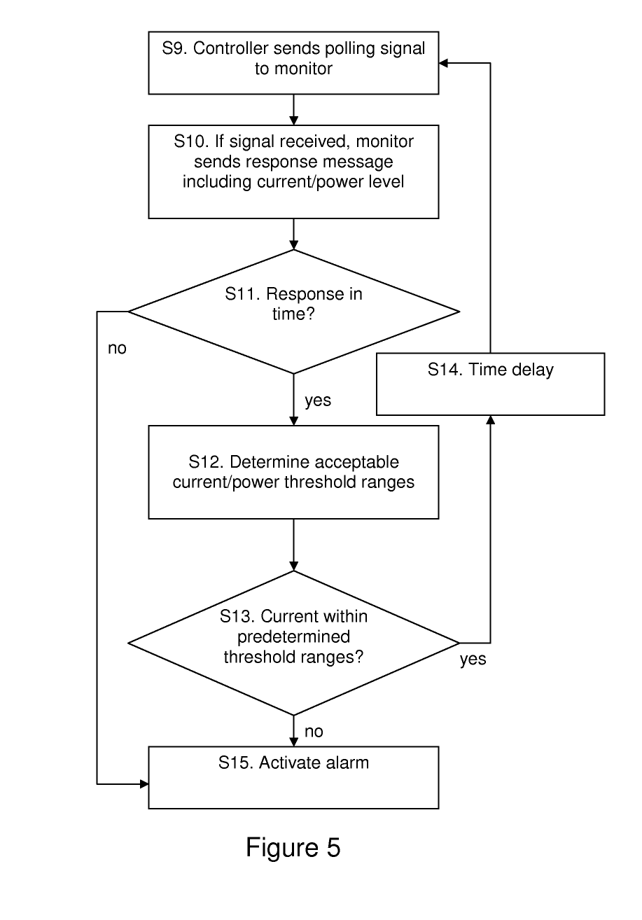

This embodiment is compatible with the previously described embodiments and may be implemented as well as the previously described embodiments or instead of the previously described embodiments. Turning now to FIG. 5, the above-described embodiment is illustrated as a flow chart, with the following numbering corresponding to the numbering of the flow chart:

S9. The controller 10 sends a polling signal to the monitor 6.
S10. If the polling signal is received, the monitor sends a response message indicating the current/power and/or power factor measured by each sensor.
S11. If the controller 10 does not receive the response message in time, or after a predetermined number of retries have been sent, the alarm is activated (go to step S15).
S12. The controller 10 determines acceptable ranges of current, power and/or power factor for each sensor depending on the type of electrical device being monitored by that sensor.
S13. If the current/power and/or power factor is not within the acceptable ranges, then the alarm is sounded (move to step S15).
S14. The current/power and/or power factor is within acceptable ranges for all sensors, so no alarm is sounded. After a predetermined time, the polling signal is sent again (return to step S9).
S15. The electrical device is deemed to be disconnected from the mains power supply, and so the alarm 13 is activated.

The controller 10 may maintain a log file of events. Such events include disconnection of an electrical device, reconnection of an electrical device, current draw or power factor measured at a sensor going outside a predetermined range, current draw or power factor at a sensor returning within a predetermined range, disconnection of a monitor, reconnection of a monitor, deactivation of a sensor, reactivation of a sensor, deletion of a sensor, addition of a sensor and change of a threshold.

In a preferred embodiment, a plurality of controllers may be used in a redundant configuration.

It will be appreciated by those of skill in the art that various modifications may be made to the above described embodiments without departing from the scope of the present invention.

1. Apparatus for providing mains electrical power to a plurality of electrical devices, the apparatus comprising:
a plurality of power outlets, each power outlet arranged to be coupled to an electrical device;
a plurality of sensors, each sensor being associated with a power outlet of the plurality of power outlets and arranged to measure at least one electrical parameter selected from current drawn, power consumption and power factor at the associated power outlet;
a communications interface for sending to a controller via a communications network a message, the message including an identity of each power outlet of the plurality of power outlets and information derived from the measured electrical parameter or parameters for each power outlet of the plurality of power outlets.

2. Apparatus according to claim 1, wherein the communications interface is further arranged to receive a polling signal from the controller, and the message is arranged to be sent in response to receipt of the polling signal.

3. Apparatus according to claim 1, further comprising a microcontroller arranged to determine whether the electrical parameter has fallen below a predetermined threshold or outside a predetermined range and, in the event that such a determination is made, to send an alert message to the remote controller via the communications network.

4. Apparatus according to claim 3, further comprising an alarm, the alarm arranged to be activated in the event that it is determined that the electrical parameter has fallen below a predetermined threshold or outside a predetermined range.

5. Apparatus according to any one of claims 1, wherein the communications network is selected from an Ethernet network, a power line network, and a wireless network.

6. A controller for use in a security system, the controller comprising:
a receiver for receiving a message from an apparatus for providing mains electrical power to a plurality of electrical devices, the message including information derived from at least one electrical parameter selected from current, power consumption and power factor measured at each power outlet of a plurality of power outlets at the apparatus;
a processor for activating an alarm in the event that the information derived from the electrical parameter or parameters has fallen below a predetermined limit or outside a predetermined range.

7. The controller according to claim 6, further comprising a transmitter for sending a polling request via a communication network to the apparatus for providing mains electrical power to a plurality of electrical devices, such that the received message is received in response to the polling request.

8. The controller according to claim 7, wherein the processor is further arranged to activate the alarm in the event that the message is not received within a predetermined time from sending the polling request and after a predetermined number of retries.

9. The controller according to claim 7, wherein the polling request is sent to a plurality of apparatus for providing mains electrical power to a plurality of electrical devices.

10. The controller according to claim 7, wherein the polling request is sent to an individual apparatus for providing mains electrical power to a plurality of electrical devices, the polling request comprising one of a request for information derived from at least one electrical parameter selected from current, power and power factor measured at all power outlets and a request for information derived from at least one electrical parameter measured at an identified power outlet.

11. The controller according to claim 6, wherein the receiver is arranged to receive an alert signal from the apparatus for providing mains electrical power to a plurality of electrical devices, and the processor is arranged to activate an alarm in the event that an alert signal is received.

12. The controller according to claim 6, comprising means to a deactivate a sensor located at a power outlet; and
the processor is arranged to either send no more polling request messages for that sensor until it receives an indication to reactivate polling request messages or to ignore negative responses from that sensor to polling request messages.

13. The controller according to claim 12, wherein the processor is arranged to receive an indication to reactivate polling request messages after any of the expiry of a predetermined time limit and receipt of a reactivation message sent from the apparatus for providing mains electrical power to a plurality of electrical devices.

14. A security system for an electrical device connected to a mains electricity supply, the security system comprising:
a monitor device located between the electrical device and the mains electricity supply, the monitor device comprising a sensor to measure an electrical parameter selected from at least one electrical parameter selected from current drawn, power and power factor relating to the electrical device, a transmitter to send a message to a controller, the message including information derived from the measured electrical parameter or parameters;
wherein the controller is arranged to activate an alarm in the event that the information derived from the measured electrical parameter or parameters is outside one or more predetermined threshold ranges, or changes at greater than a predetermined rate.

15. The security system according to claim 14, wherein the monitor device further comprises a receiver to receive a polling signal sent from the remote controller, wherein the message is arranged to be sent in response to the polling signal.

16. The security system according to claim 14, wherein the predetermined thresholds correspond to typical power usage states of the electrical device.

17. The security system according to claim 14, further comprising a database accessible by the controller, the database containing information selected from typical electrical parameter values and rates of change of electrical parameter values for a plurality of electrical devices.

18. A controller for use in a security system, the controller comprising:
a receiver arranged to receive a message from a monitor device, the monitor device being located between an electrical device and a mains electricity supply and comprising a sensor device arranged to measure at least one electrical parameter selected from current drawn, power and power factor relating to the electrical device, and the message including information derived from the measured electrical parameter or parameters;
a processor arranged to determine whether the information derived from the measured electrical parameter or parameters is outside one or more predetermined threshold ranges, or has changed at more than a predetermined rate; and
means to activate an alarm in the event that the information derived from the measured electrical parameter or parameters is outside one or more predetermined threshold ranges, or has changed at more than a predetermined rate.

19. The controller according to claim 18, further comprising a transmitter for sending a polling signal to the monitor device, the polling signal requesting the message.

20. The controller according to claim 19, further comprising means to activate the alarm in the event that the message from the monitor is not received within a predetermined time limit, and after a predetermined number of retries, after sending the polling signal.

21. A computer readable storage device storing a computer program which, when run on a computer device, causes the computer device to behave as a controller according to claim 6.
